(19) United States
(12) Patent Application Publication
(10) Pub. No.: US 2003/0208752 A1
(43) Pub. Date: Nov. 6, 2003

(54) Employee candidate computer and web-based interactive assessment software and method of employee candidate assessment

(76) Inventor: Veleria Farris, Mableton, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/137,990

(22) Filed: May 3, 2002

(51) Int. Cl. H04N 7/16; H04H 9/00; H04N 7/173; H04N 7/025; H04N 7/10; G09G 5/00

(52) U.S. Cl. 725/13; 725/24; 725/34; 725/135; 345/731; 345/745

(57) ABSTRACT

Employee candidate computer and web-based interactive assessment software providing a system and method of evaluating a potential employee's competency and skill via the employ of web-based streaming video applications or desktop computer applications to present potential candidates with a series of employee-customer scenarios and related questions requiring interactive responses, wherein the type of responses submitted enable employers to more efficiently select potential employees whom they believe possess the requisite level of skill for a particular job position/application.

### TECHNICAL FIELD

The present invention relates generally to employee candidate assessment programs and more specifically to an employee candidate computer and web-based interactive assessment software and method of employee candidate assessment. The present invention is particularly useful for, although not limited to, assisting companies in the hiring and retention of efficient employees.

### BACKGROUND OF THE INVENTION

A company's ability to maintain customer loyalty typically hinges on the relentless pursuit of sustained customer satisfaction. Although the preservation of customer satisfaction is dependant upon a multitude of factors, employee-customer interaction is typically considered the foremost element. As such, a company's successful selection and retention of a competent and efficient staff is usually directly proportional to each individual employee's capacity to handle an assortment of customer-relation scenarios including, but not limited to, customer needs, service complaints and/or technical questions. Unsurprisingly, hiring a skilled and proficient employee base is an expensive and time-consuming process, often involving an extensive interview process requiring much planning and employee-candidate deliberation.

As expected, the employee-hiring process characteristically involves devotion of company time and money. Cost for such processes can run into the hundreds of thousands of dollars, or even millions, making a fruitless interview and/or hiring experience a regretful and expensive affair. For instance, taking into account basic hiring expenses such as employee orientation, legal fees, compliance, employee relations and employment liability, the typical annual human resource cost per employee can easily exceed $150,000 for a medium to large company.

Expenses accrue even in fruitful employee searches. If bombarded with hundreds of candidate employment applications, a company's human resources division must usually undergo an extensive weeding-out process, selecting applicants whom they anticipate will provide the requisite level of skill for an employment position. Unfortunately, however, after expenditure of much time and money conducting personal interviews with such potential candidates, many employers either leave empty-handed or hire individuals whom they later discover to possess unacceptable inadequacies and/or incompetence. Moreover, in addition to the time and money wasted in the hiring process, an ineffectual employee may directly and/or indirectly cause a company to lose money, such as on salary, benefits, advertising, employee training, overtime, downtime, lost revenue, possible legal fees and various lost opportunities.

Attracting qualified employees typically entails promoting the company name and/or sending out notification of the company's intent to hire to otherwise uninformed potential employees. As such, searching for promising employee candidates often requires recruiters to travel extensively to job-fair sites, such as college campuses, and to engage in hiring and interviewing processes that are otherwise preferably conducted in-house and on a more formal level. Moreover, although teeming with recruits, most such job-fairs are usually inefficient and not conducive to in-depth individual assessment, thus usurping from the recruiter the ability to effectively screen and/or test prospective employees.

Therefore, it is readily apparent that there is a need for an employee candidate computer and web-based interactive assessment software and method of employee candidate assessment, wherein a company utilizes computer and/or web-based applications to evaluate, profile and record a potential employee's analytical ability, capacity to handle customer relations and/or problem-solve, thus dramatically reducing the need for time-consuming and costly face-to-face interviews and streamlining the conventional recruitment processes.

### BRIEF SUMMARY OF THE INVENTION

Briefly described, in a preferred embodiment, the present invention overcomes the above-mentioned disadvantages, and meets the recognized need for such a device by providing an employee candidate computer and web-based interactive assessment software, wherein a company utilizes web-based, network or desktop computer streaming video applications to present or simulate multiple employee-customer scenarios and to pose related questions that require employee candidate interaction and response, thus enabling an employer to evaluate, profile and record a potential employee's analytical ability, capacity to handle customer relations and/or to problem-solve based on the responses tendered.

According to its major aspects and broadly stated, the present invention in its preferred form is an employee candidate computer and web-based interactive assessment software providing a method of evaluating a potential employee's competency and skill via the utilization of web-based, network or desktop computer streaming video applications to present potential candidates with a series of employee-customer scenarios and related questions requiring interactive responses, wherein the type of responses submitted enable employers to more efficiently select potential employees possessing the requisite level of skill for a particular job position.

More specifically, the present invention is an employee candidate computer and web-based interactive assessment software, wherein the software is installed on a desktop computer or is run as a network or web-based application. The employee candidate assessment software program is rendered accessible by a potential employee through utilization of an employer-provided log-in password that is input via a desktop interactive graphical interface or an on-line interactive menu. After logging in, the applicant is presented with a series of videos that may simulate various employee-customer scenarios, employer-employee scenarios or other scenarios designed to elicit targeted responses for subsequent evaluation. Following the presentation of the videos, the applicant is presented with related questions designed to assess the applicant's ability to analyze, handle customer relations and/or problem-solve. Based on the type of response given by the applicant, an employer is able to accurately evaluate the applicant's strengths and weaknesses, and to use that information to make an educated hiring decision, thereby greatly reducing time/money lost in hiring employees later discovered to be unskilled or incompetent, and often eliminating the necessity of a personal interview altogether.

A feature and advantage of the present invention is its ability to identify problem-solving, analytical and customer handling skills and abilities in employee candidates.

A feature and advantage of the present invention is its ability to reduce the need for face-to-face interviews, conventional recruitment processes and/or other forms of personal interviews, thus saving the time and money of a hiring company.

A feature and advantage of the present invention is its ability to run as a web-based application, thus enabling worldwide recruitment without extensive travel by avoiding the necessity of face-to-face interviews or other forms of personal interviews.

A feature and advantage of the present invention is its ability to be installed and run from any desktop computer, thus enabling an individual to apply and “interview” for a job position from any geographic location by avoiding the necessity of face-to-face interviews or other forms of personal interviews.

A feature and advantage of the present invention is its ability to be used as a company's in-house assessment program for employee development and executive succession planning.

A feature and advantage of the present invention is its ability to enable a hiring company/employer to process up to 70% more candidates than accomplished through personal interviews.

A feature and advantage of the present invention is its ability to automatically track and record applicant demographics, including, but not limited to, residence, experience level, educational level, previous employment, and/or desired salary.

A feature and advantage of the present invention is its ability to automatically track and record any personal information submitted by the applicant.

A feature and advantage of the present invention is its ability to automatically track and record Affirmative Action data and other pertinent legal documentation.

A feature and advantage of the present invention is its ability to automatically track and record applicant responses/demographics that were considered in the hiring or non-hiring of the applicant.

A feature and advantage of the present invention is its ability to provide a future reference source of data considered in the hiring or non-hiring of the applicant.

A feature and advantage of the present invention is its ease of use and operation.

A feature and advantage of the present invention is its ability to be designed to meet the assessment criteria and standards particular to each hiring company/employer.

A feature and advantage of the present invention is its ability to incorporate the use of streaming computer or on-line video simulations of employee-customer scenarios accompanied by related interactive questions, responses to which are used to assess an applicant's skill and competency.

A feature and advantage of the present invention is its ability to incorporate the use of streaming computer or on-line video simulations of any assessment scenario accompanied by related interactive questions, responses to which are used to assess an applicant's skill and competency.

A feature and advantage of the present invention is its ability to reduce a company's cost and time from that generally associated with an extensive interview process.

A feature and advantage of the present invention is its ability to be run on platforms such as, but not limited to, MICROSOFT SQL and ORACLE.

A feature and advantage of the present invention is its ability to have cross platform capabilities.

A feature and advantage of the present invention is its ability to be coupled with live telephone interviews and/or employee-candidate-tests, wherein the results of the telephone interview and tests can be entered into the software program database.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a graphical interface provided by an employee candidate computer and web-based interactive assessment software according to a preferred embodiment of the present invention showing the first graphical image presented on a computer screen to a user.

FIG. 2 is a graphical interface provided by an employee candidate computer and web-based interactive assessment software according to a preferred embodiment of the present invention showing the second graphical image presented on a computer screen to a user.

FIG. 3 is a graphical interface provided by an employee candidate computer and web-based interactive assessment software according to a preferred embodiment of the present invention showing the third graphical image presented on a computer screen to a user.

FIG. 4 is a graphical interface provided by an employee candidate computer and web-based interactive assessment software according to a preferred embodiment of the present invention showing the fourth graphical image presented on a computer screen to a user.

FIG. 5 is a graphical interface provided by an employee candidate computer and web-based interactive assessment software according to a preferred embodiment of the present invention showing the fifth graphical image presented on a computer screen to a user.

FIG. 6 is a graphical interface provided by an employee candidate computer and web-based interactive assessment software according to a preferred embodiment of the present invention showing the sixth graphical image presented on a computer screen to a user.

FIG. 7 is a graphical interface provided by an employee candidate computer and web-based interactive assessment software according to a preferred embodiment of the present invention showing the seventh graphical image presented on a computer screen to a user.

FIG. 8 is a graphical interface provided by an employee candidate computer and web-based interactive assessment software according to a preferred embodiment of the present invention showing the eighth graphical image presented on a computer screen to a user.

FIG. 9 is a graphical interface provided by an employee candidate computer and web-based interactive assessment software according to a preferred embodiment of the present invention showing the ninth graphical image presented on a computer screen to a user.

FIG. 10 is a graphical interface provided by an employee candidate computer and web-based interactive assessment software according to a preferred embodiment of the present invention showing the tenth graphical image presented on a computer screen to a user.

FIG. 11 is a graphical interface provided by an employee candidate computer and web-based interactive assessment software according to a preferred embodiment of the present invention showing the eleventh graphical image presented on a computer screen to a user.

FIG. 12 is a graphical interface provided by an employee candidate computer and web-based interactive assessment software according to a preferred embodiment of the present invention showing the twelfth graphical image presented on a computer screen to a user.

FIG. 13 is a graphical interface provided by an employee candidate computer and web-based interactive assessment software according to a preferred embodiment of the present invention showing the thirteenth graphical image presented on a computer screen to a user.

FIG. 14 is a graphical interface provided by an employee candidate computer and web-based interactive assessment software according to a preferred embodiment of the present invention showing the fourteenth graphical image presented on a computer screen to a user.

FIG. 15 is a graphical interface provided by an employee candidate computer and web-based interactive assessment software according to a preferred embodiment of the present invention showing the fifteenth graphical image presented on a computer screen to a user.

FIG. 16 is a graphical interface provided by an employee candidate computer and web-based interactive assessment software according to a preferred embodiment of the present invention showing the sixteenth graphical image presented on a computer screen to a user.

FIG. 17 is a graphical interface provided by an employee candidate computer and web-based interactive assessment software according to a preferred embodiment of the present invention showing the seventeenth graphical image presented on a computer screen to a user.

FIG. 18 is a graphical interface provided by an employee candidate computer and web-based interactive assessment software according to a preferred embodiment of the present invention showing the eighteenth graphical image presented on a computer screen to a user.

### DETAILED DESCRIPTION OF THE PREFERRED AND ALTERNATIVE EMBODIMENTS

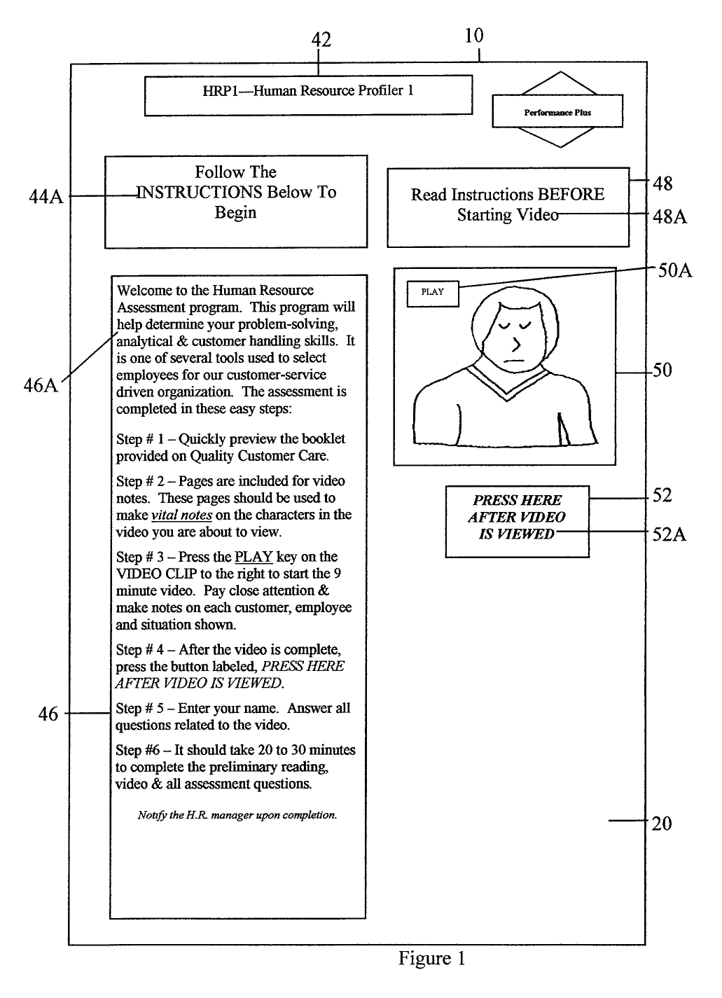

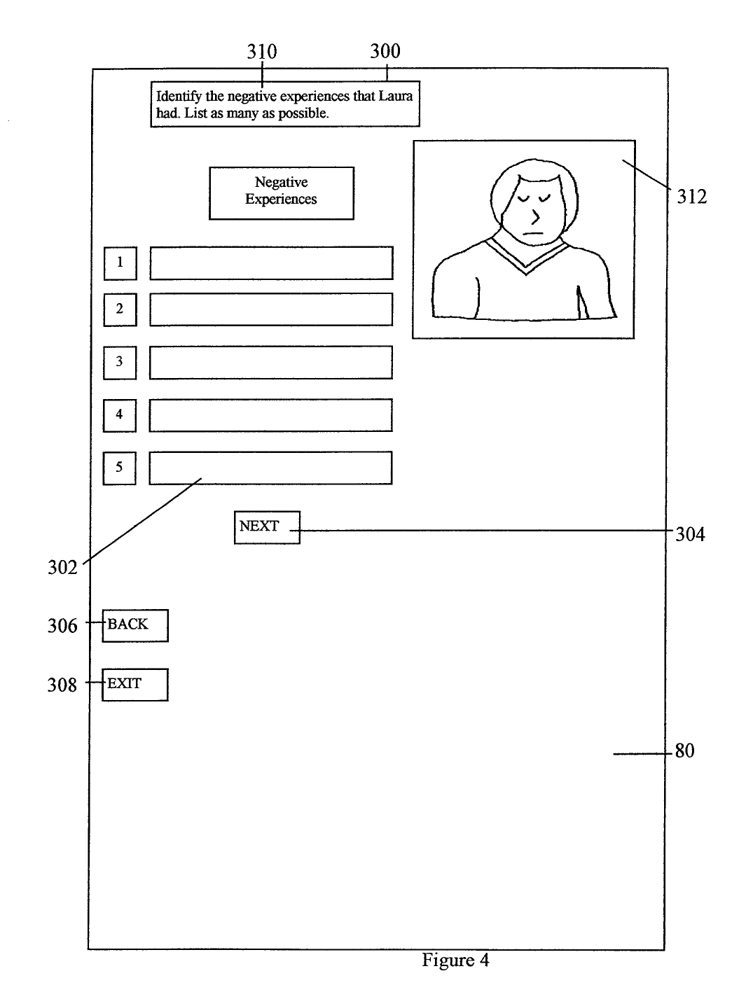

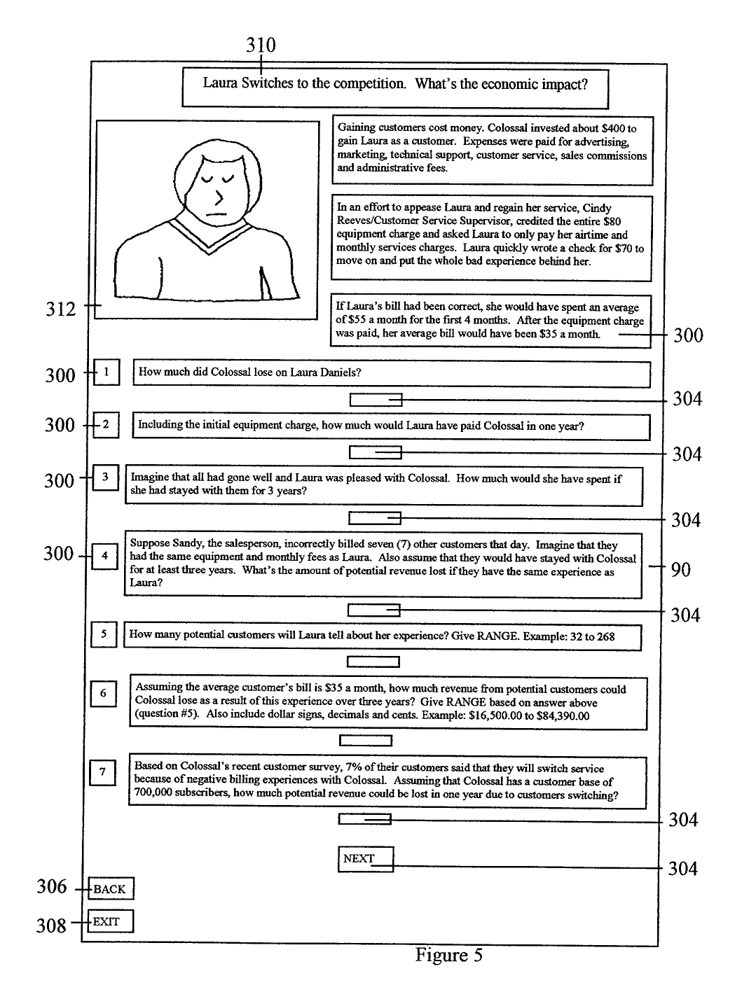

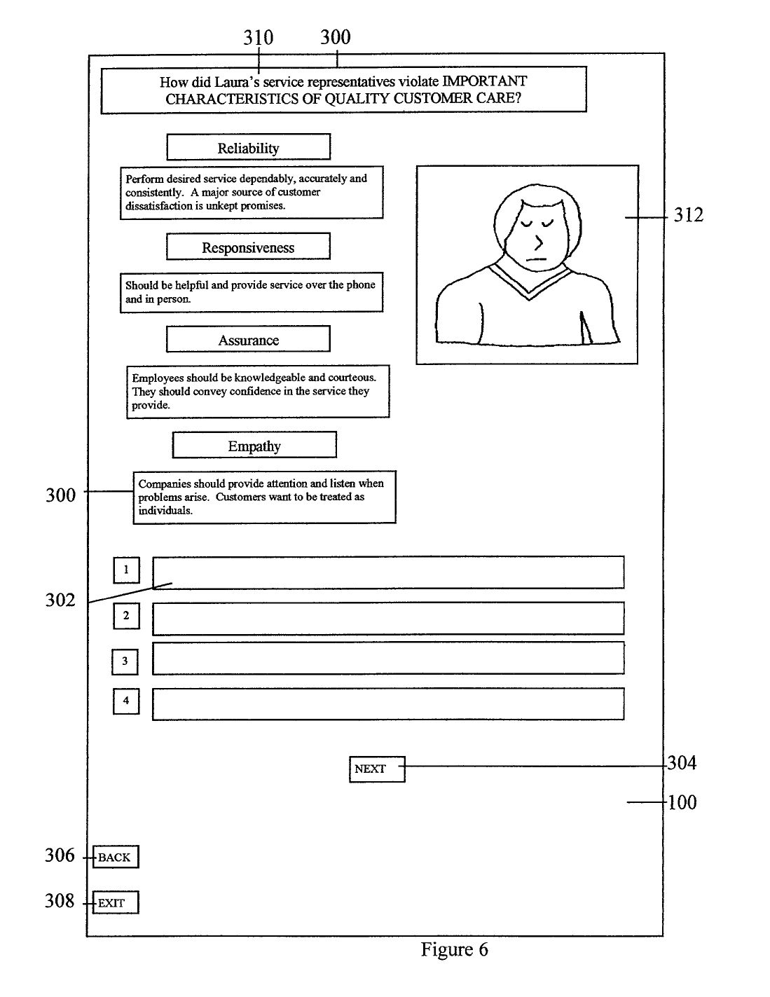

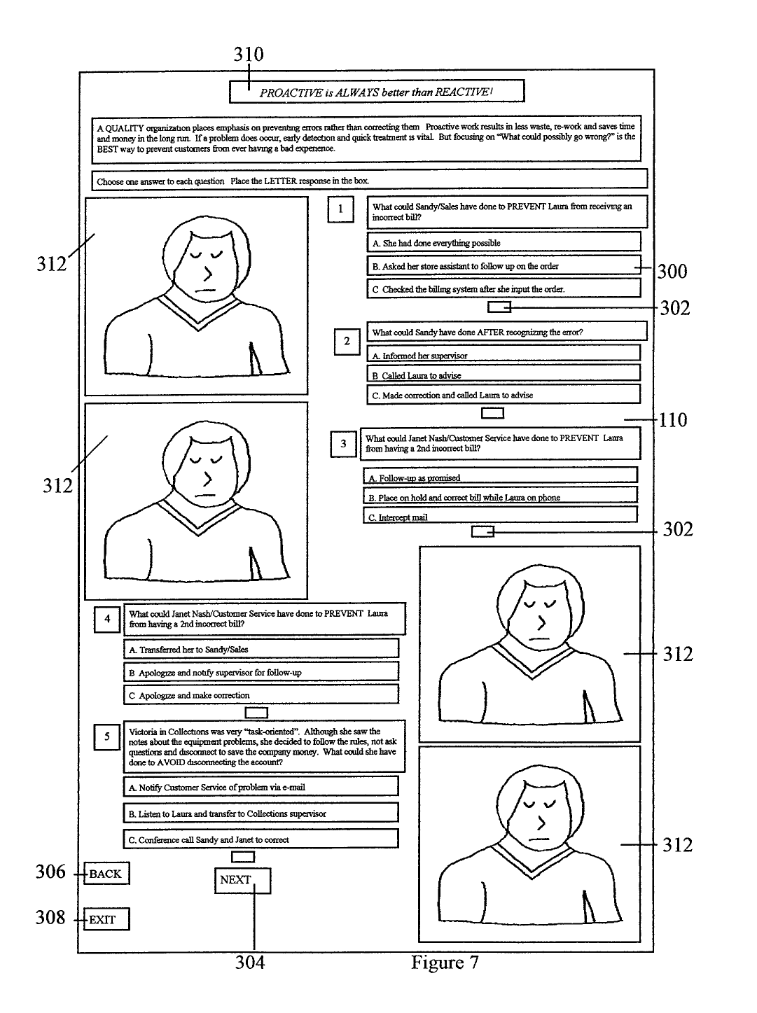

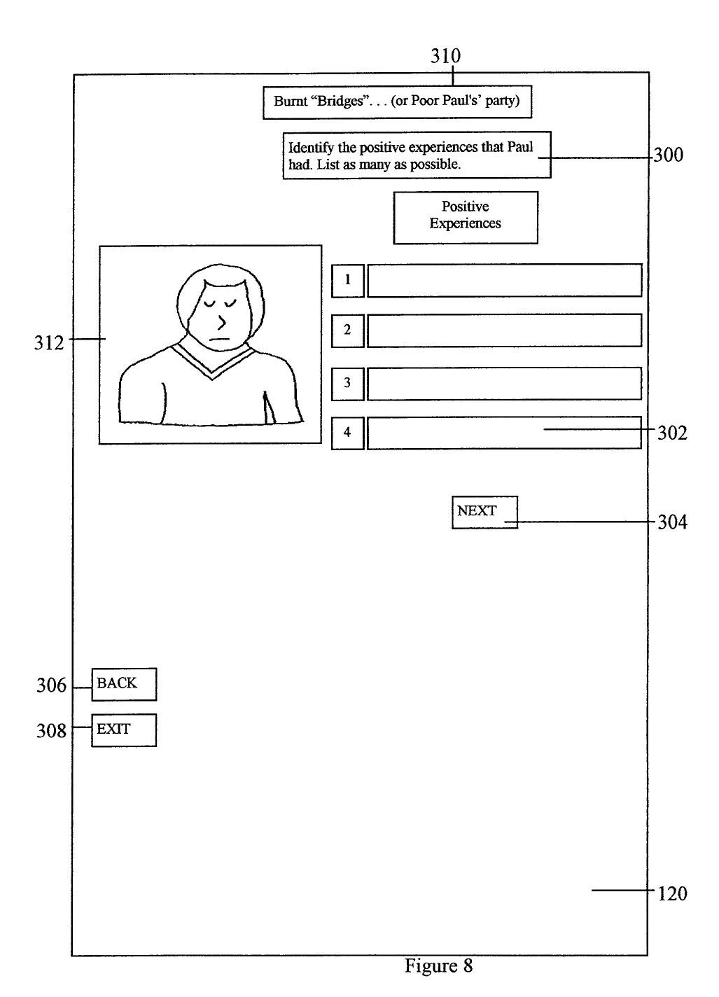

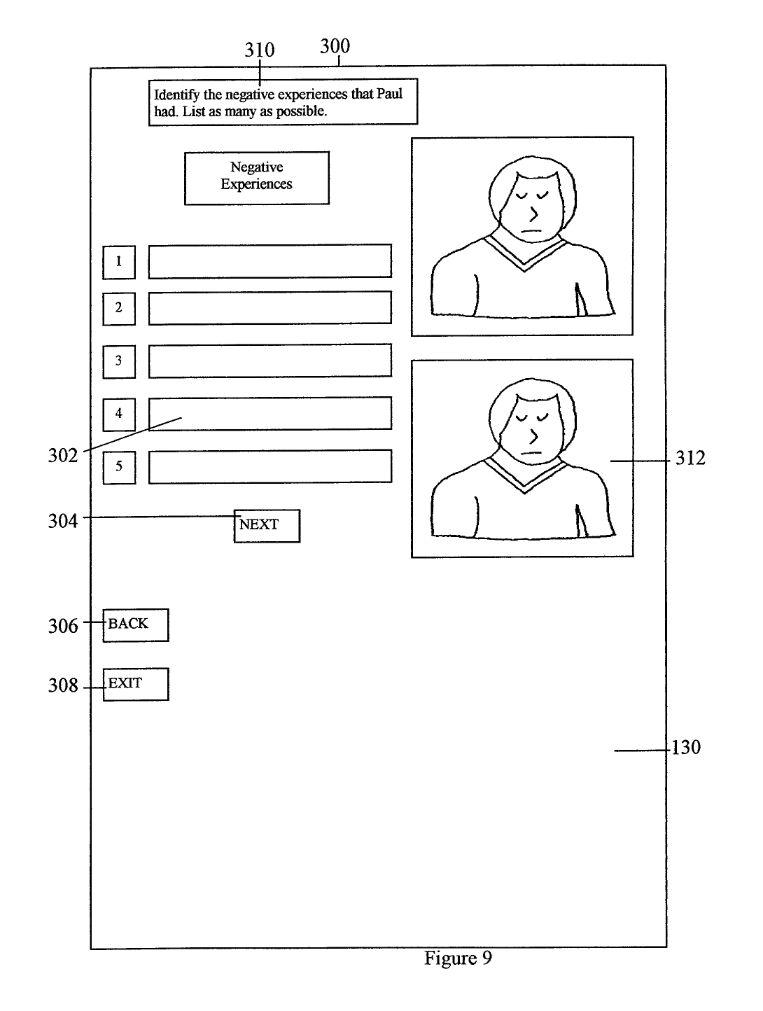

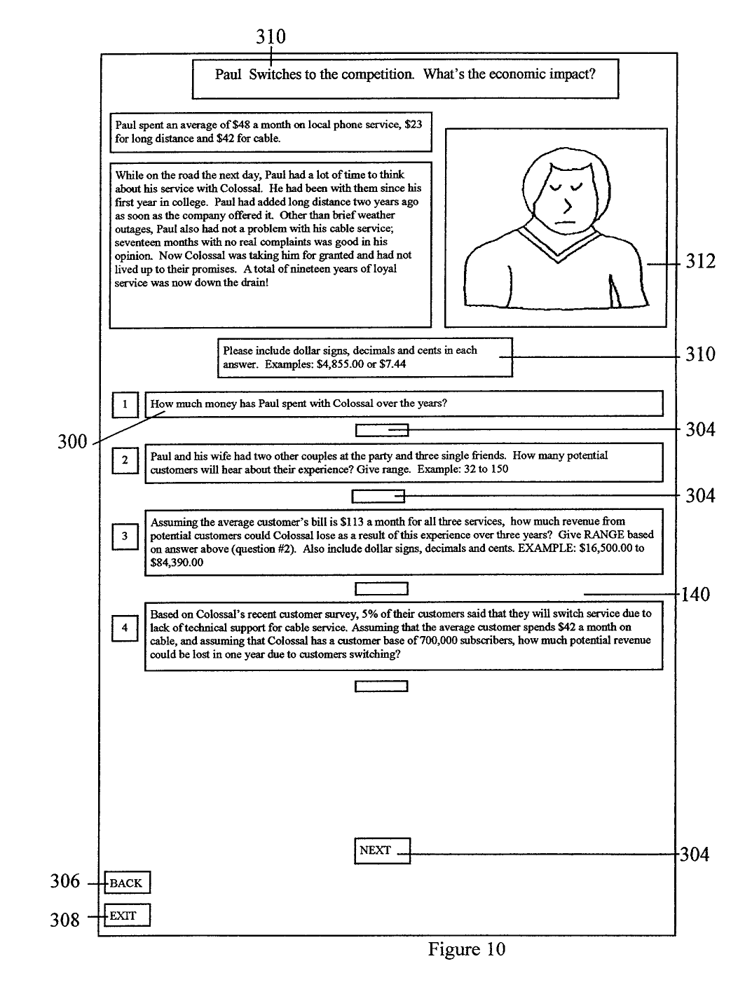

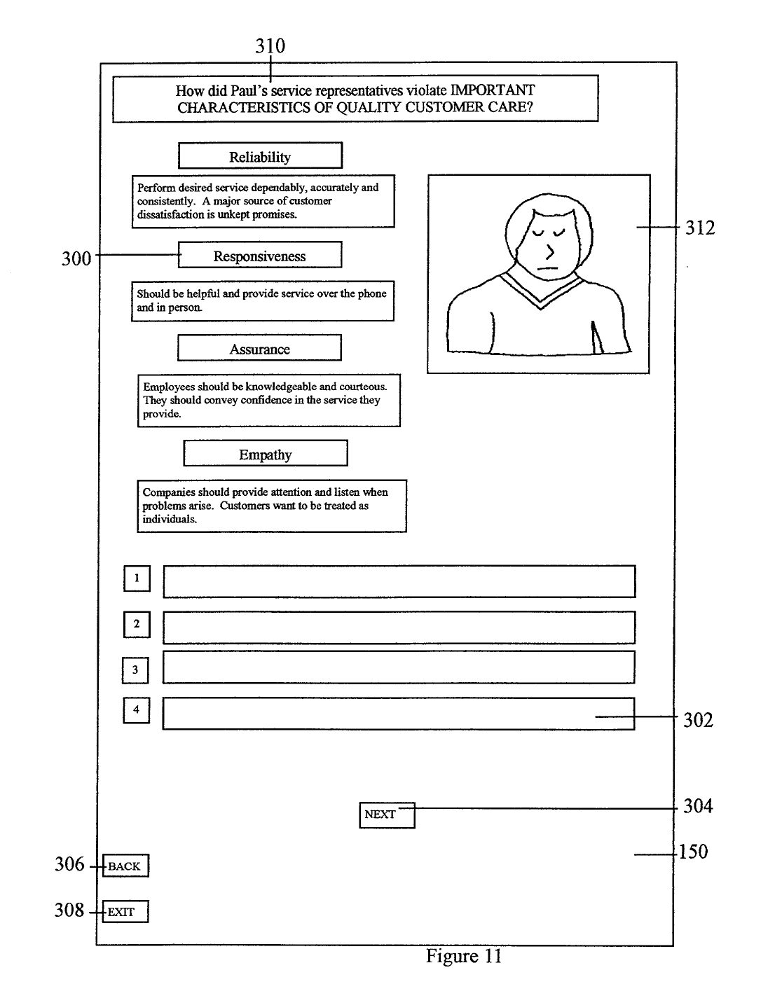

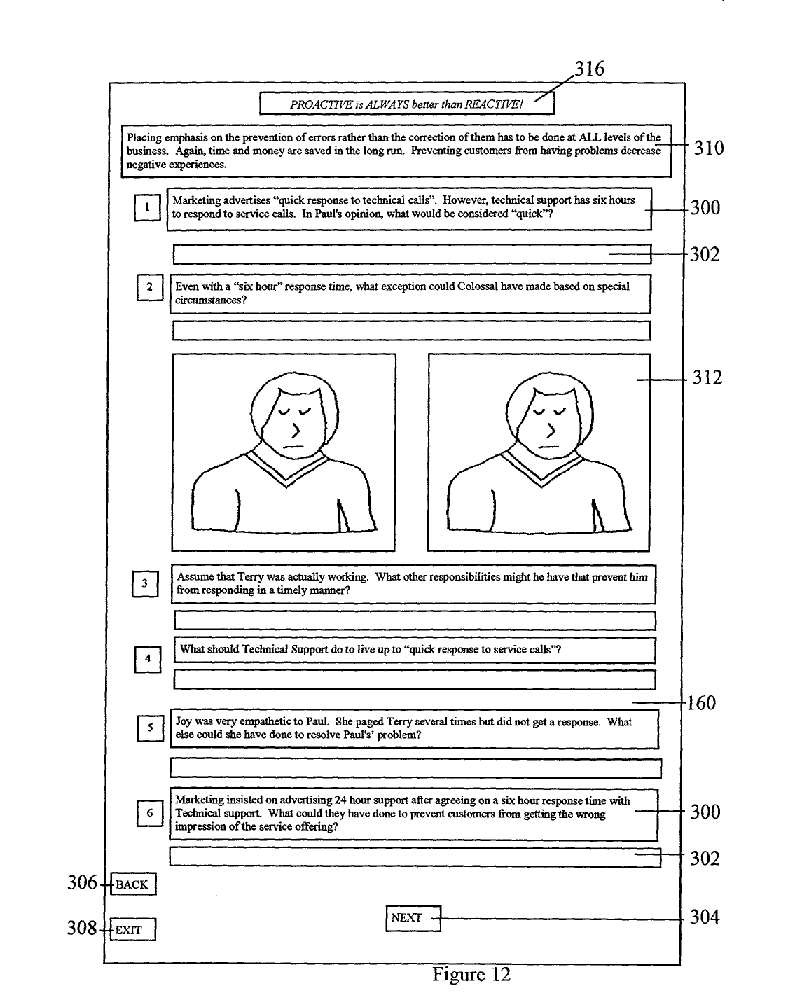

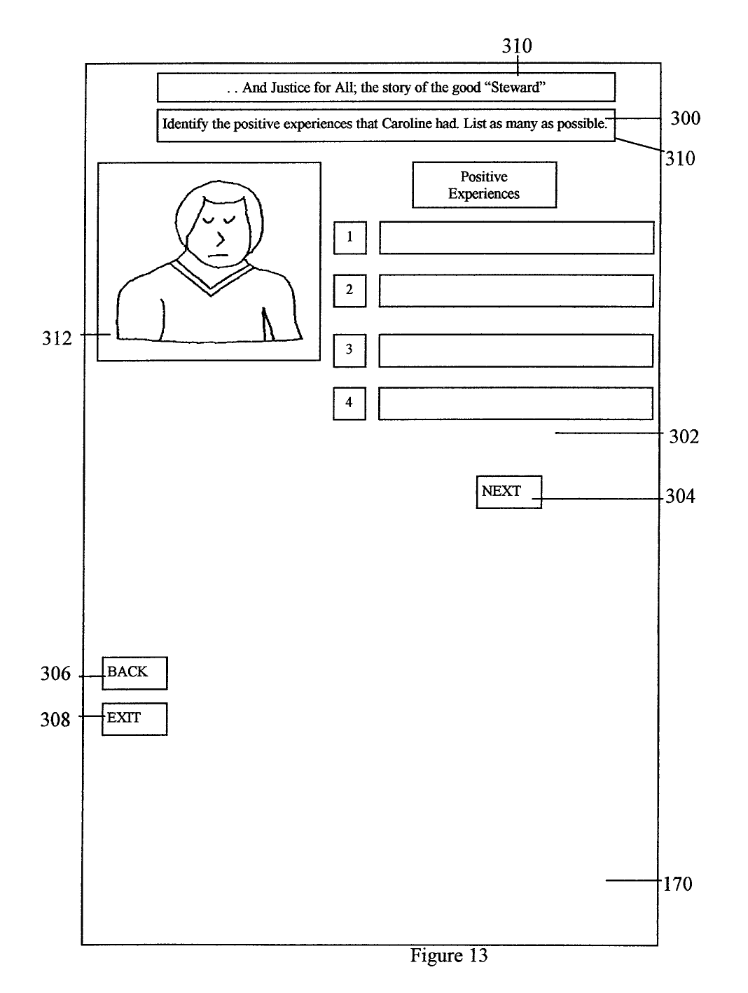

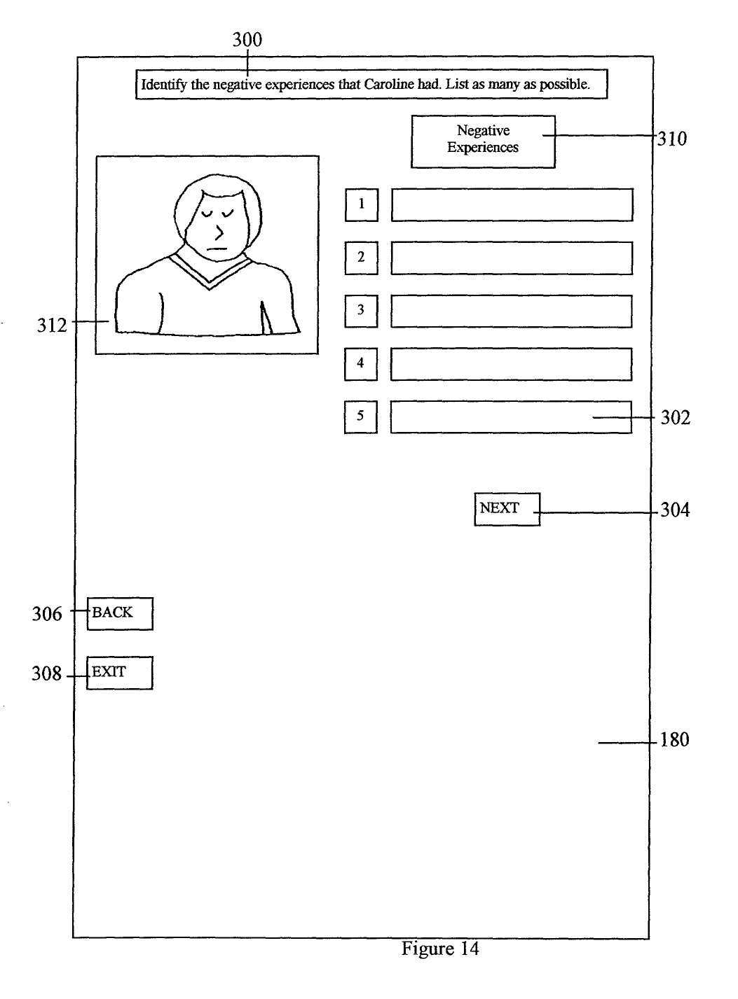

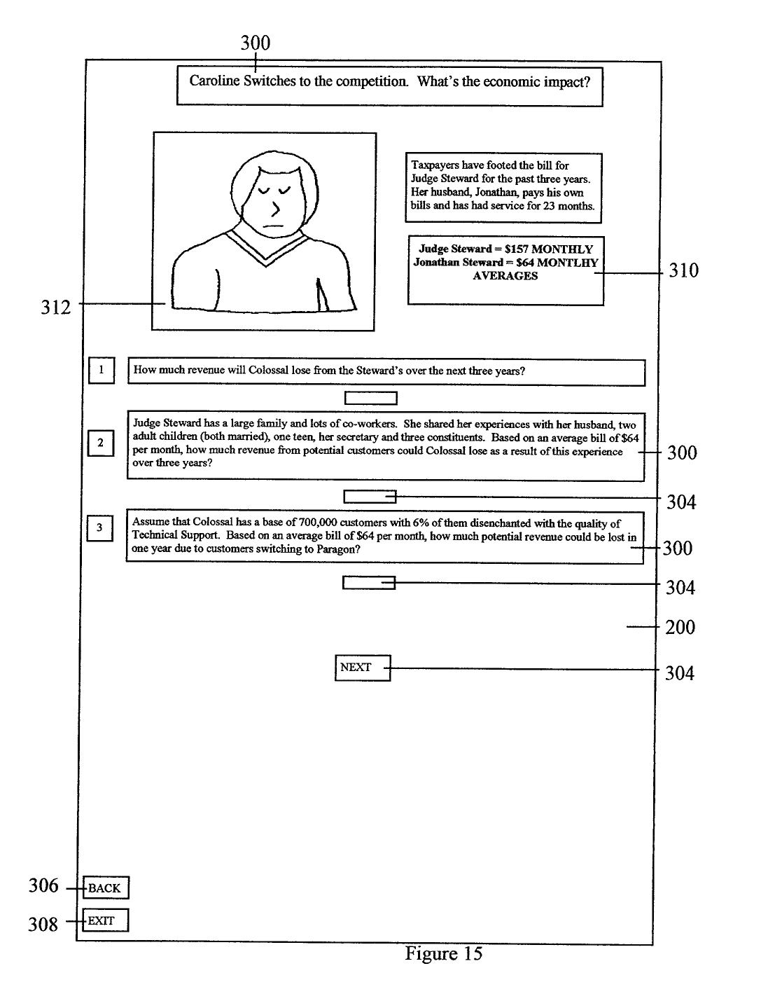

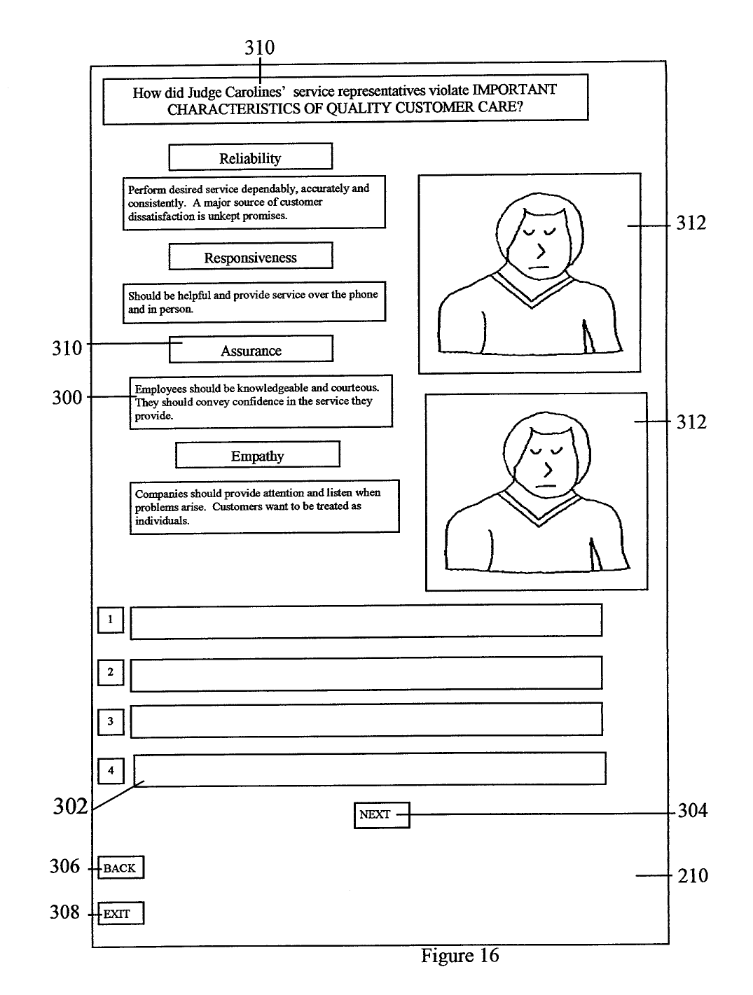

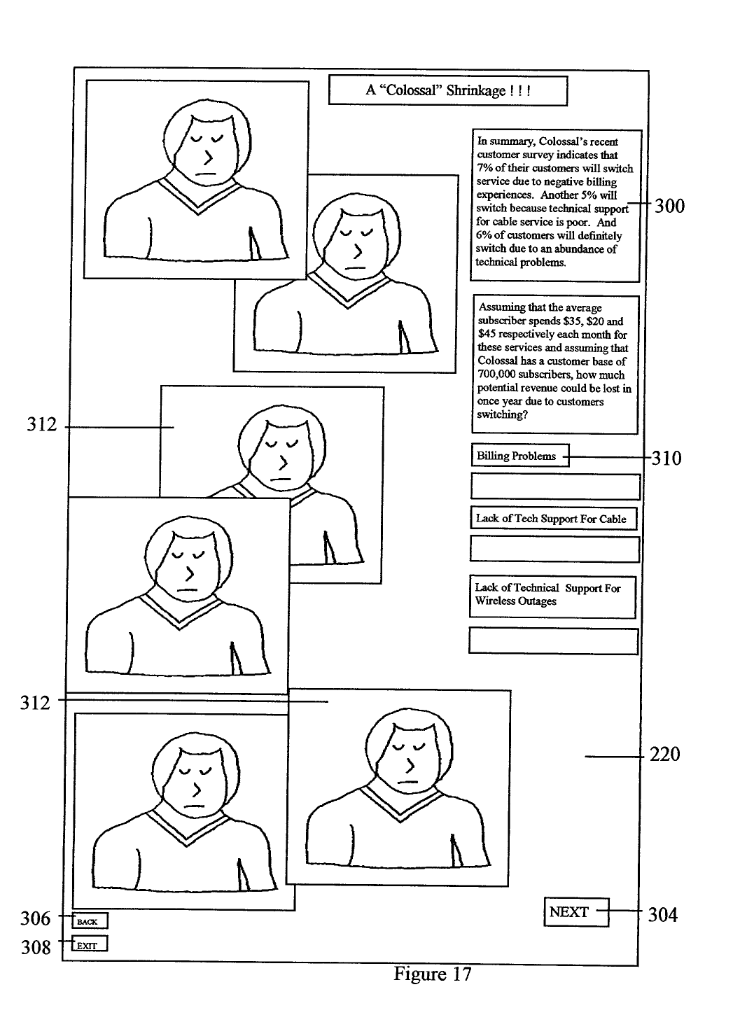

In describing the preferred and alternate embodiments of the present invention, as illustrated in FIGS. 1-18, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-18, the present invention in its preferred embodiment is an employee candidate computer and web-based interactive assessment software and method thereof 10, preferably comprising a graphical interface 20 capable of displaying graphical images 40, 60, 70, 80, 90, 100, 110, 120, 130, 140, 150, 160, 170, 180, 200, 210, 220 and 230 thereon, wherein software and method 10 is installed, configured, accessed and utilized via a desktop computer or accessed and utilized as a global networking system application. Furthermore, although graphical images 40, 60, 70, 80, 90, 100, 110, 120, 130, 140, 150, 160, 170, 180, 200, 210, 220 and 230 are the preferred graphical images used to define software and method 10, graphical images 40, 60, 70, 80, 90, 100, 110, 120, 130, 140, 150, 160, 170, 180, 200, 210, 220 and 230 are exemplary of an infinite number of graphical images that can be used to define software and method 10.

Referring specifically now to FIG. 1, graphical image 40 is shown disposed on graphical interface 20, wherein graphical image 40 preferably comprises introductory instructional data 46A for the user and a user-selectable means 52A for initiating the assessment procedure. Preferably, the assessment procedure begins with the display of a video image from graphical video image box 50, wherein graphical image 40 preferably includes a user-selectable mechanism 50A to begin video play. While a user-selectable play button 50A is preferred, other methods of initiating video play are contemplated, such as, for exemplary purposes only, timed delay or auto-start following confirmation of instruction review.

In the preferred embodiment, graphical image 40 comprises text boxes 42, 44, 46 and 48, graphical video image box 50 and advance button 52; however, any other combination of text and/or video boxes and selectable buttons may be utilized to perform substantially the same purposes as illustrated herein. The preferred illustrated text, as follows, is exemplary of the preferred content of introductory instructional list 46A. However, alternate text and/or words and/or images may be utilized to convey to a user the intended message and/or information. Text box 42 preferably displays software title 42A therein. Similarly, text boxes 44 and 48 preferably display instructional titles 44A and 48A, respectively, therein. Text box 44 preferably reads as follows:

Follow The
INSTRUCTIONS
Below To Begin

Likewise, text box 48 preferably reads as follows:

Read Instructions Before
Starting Video

Text box 48 is preferably positioned over graphical video image box 50 on graphical image 40. However, text box and/or image box positioning on any of graphical images 40, 60, 70, 80, 90, 100, 110, 120, 130, 140, 150, 160, 170, 180, 200, 210, 220 and 230 may have any arrangement conducive to the effective communication of intended info.

Text box 44 is preferably positioned over text box 46 on graphical image 40, wherein text box 46 preferably contains an instructional list 46A that preferably reads as follows:

Welcome to the Human Resource Assessment
program. This program will help determine
your problem solving, analytical &
customer handling skills. It is one of
several tools used to select employees for
our customer-service driven organization.
The assessment is completed in these easy
steps:
Step #1 - Quickly preview the booklet
provided on Quality Customer Care.
Step #2 - Pages are included for video
notes. These pages should be used to make
vital notes on the characters in the video
you are about to view.
Step #3 - Press the PLAY key on the VIDEO
CLIP to the right to start the 9 minute
video. Pay close attention & make notes
on each customer, employee and situation
shown.
Step #4 - After the video is complete,
press the button labeled PRESS HERE AFTER
VIDEO IS VIEWED.
Step #5 - Enter your name. Answer all
questions related to the video.
Step #6 - It should take 20 to 30 minutes
to complete the preliminary reading, video
& all assessment questions.
Notify the H.R. manager upon completion.

Text boxes 42, 44, 46 and 48 can be designed to display any information, instruction and/or text deemed relevant to the employer.

Graphical video image box 50 preferably comprises a play button 50A, wherein “clicking” on play button 50A with a conventional computer mouse and graphical cursor results in the activation of a streaming video clip from graphical video image box 50. The streaming video clip from graphical video image box 50 can be any type of video clip such as, for exemplary purposes only, employee training videos or customer-employee scenarios. A typical video clip may comprises the following dialogue:

Narrated Introduction
Sam Goodheart is president of Colossal Communications,
a conglomerate offering a variety of telecommunication
services. On this day he is working on proposal to the
Board of Directors of Colossal on ways to stop customers
from leaving the company - when a dose of hard reality
hits him and Colossal.
Scene 1
At Paragon Company Customer Service Center:
Customer 1: I have never been so frustrated, angry and
well . . . just so enraged in all my life. It took Colossal
Communications three months to straighten out my bill.
They . . . they just wouldn't listen when I tried to explain it
to them. Can you deliver better service if we switch to
you?
Service Representative: That must have been extremely
frustrating. It doesn't even take three months to build a
new house these days. Well . . . Mr. Adams we will give you the
best customer service experience you've ever had. In fact,
I can schedule the Service Technician to come out to your
home today and reprogram your phones. You and your wife
can start enjoying a new total communications life with
Paragon all before the end of the day, so . . . what will be a
convenient time for you, Mr. Adams?
Scene 2
At Colossal Communications Headquarters:
Sam Goodheart: Lets see now, I told them about expanding
our coverage area in the northern regions, investing in
advanced technology, building internal systems and . . .
Lynn: Increasing our customer support staff sir.
Sam Goodheart: Yeah . . . that sounds like a solid plan for
keeping customers. Let me just add some finishing touches
to it but that's all for now Lynn. Anything else?
Lynn: Yes sir, an angry customer called this morning about
a problem. She was so angry she said she is switching to
Paragon. Cindy in customer service handled the call and
took care of the issues, but since you wanted the Board of
Directors to consider your proposal on saving customers, I
thought you might want to know.
Sam Goodheart: No, I'm sure Cindy took care of it.
Anything else?
Lynn: No sir, I'll have these ready for you shortly.
Sam Goodheart: Good. Oh, get Stephen on the phone. I
need to check his network report pronto.
Lynn: Right away, sir.
Scene 3
At Colossal Communications Headquarters:
Laura Daniels: Hello, Mr. Goodheart, I'm Laura Daniels, a
former customer.
Sam Goodheart: Ms. Daniels, please come in. How can I turn
you into a current customer?
Laura Daniels: I doubt there is anything you can do to get
me back. I have had it with those idiots down in
collections. I think you need a wake up call to what is
really going on with Colossal Communications. I figured
why not get a mobile phone. I'm out sometimes late at
night. It will be there in case of an emergency, I planned
on eventually getting one. What have I got to lose? Time,
time, was what I had to lose. She even offered to charge
to my monthly bill in four installments of $20.00 each, a
great deal right? It was so good that I even made notes
while I was talking to her. Lets see here they are. A new
phone, no activation fee, and spread the cost of the unit
over a few months, to good to be true. Oh it was! But
when the bill came, it was like I was on a different planet
and so was your staff. First of all, the entire $80.00 was
tacked onto the first month's bill and when I called to
straighten it out, all I got was attitude. The first
person was Janet Mesh in customer service . . ., if you can call
it that. She says, “No problem, I'll get it taken off the
bill and just pay the agreed upon $20.00 per month and the
other regular charges”. I thought everything was under
control until I got the next bill. The $80.00 charge was
still on the bill and then you folks had the nerve to hit
me with a past due charge. The next time I called I got
Jeff. He was useless. All he could do was tell me call
Sandy back since she was the sales rep that had keyed this
information in, it was wrong, and she was the one who could
fix it. But the final straw was when I got a call at home
from Victoria in the Collections Department. She proceeded
to tell me my service was disconnected and wants to know
when she can expect a final payment on my account. She
refused to listen to me or my explanation about the account
and she told me to call Sandy or customer service to
straighten it out. By this time, T am sick of this merry-
go-round.
Sam Goodheart: Ms. Daniels let me assure that you . . .
Laura Daniels: You can't assure me of anything. What are
you telling me? That this is not going to happen again?
Oh - it's not going to happen again, at least not to me,
because I will never do business with your company again.
The only way I got this foolishness straightened out in the
first place was Cindy Reeves; she seems to be the only
person in your company that knows anything about customer
service.
Sam Goodheart: What I want you to know is that your
concerns are being taken care of, hopefully with the new
billing system we are installing. Once implemented it will
totally eliminate this from happening ever again. Of
course you can't underestimate the importance that customer
service plays in making this system work.
Laura Daniels: That's right about customer service and
while new systems are great, they are only as good as the
people behind them.
Exit Laura Daniels
Scene 4
Brief View of Paragon Service Rep: And thank you, sir, for
choosing Paragon Broadcasting, where our customer needs are
the first priority.
At Colossal Communications Headquarters:
Sam Goodheart: Lynn?
Lynn: Yes Mr. Goodheart?
Sam Goodheart: Did we ever hear from Steve Pierson on that
research he was doing?
Lynn: He said he would E-mail you a note from the road and
attach his report.
Sam Goodheart: Lets see what we've got here. There is his
email. What's this . . . (Reading the E-mail) “You've got a
problem? Since I can only get your voicemail, computers
and office assistants are blocking my way to you on the
phone, I figure this is best way to get your attention.”
What the . . .? How did this guy get my email address?
(Reading the E-mail) “First of all I want to let you
that as of this afternoon my account and my money are going
to Paragon Communications after your employees sent me over
the edge.”
Man this guy is really mad. What set him off?
(Reading the E-mail) “What started as a simple repair
problem ended up with an even bigger mess because of your
incompetent staff. There we were at my house with a lot of
friends over to watch the football game. The refrigerator
was full of beer and food and we attended to every little
detail just to make sure it was going to be a perfect
afternoon. And then the cable went out for no reason,
there was no rain. We couldn't get a picture of any kind
that was only available on pay TV. So I called up Colossal
customer service just like it says on the bill and spoke
with someone named Joy. She told me the company responds to
problem like this within six hours. Now remember the game
is still going on. Then she told me that she paged the
service technician several times and never got an answer.
By this time, we moved the entire party over to the
Winston's house and had to pay another fee. And as for
your promise for quick response in 24 hour service is about
as believable as . . . a used car salesman who claims to sell
you a car that has only been driven by a widow to church on
Sunday. Right now I'm still angry. But rather than
getting mad, I'm just getting out. Out of doing business
with Colossal. I moved all accounts to Paragon. Will they
treat me any better? Who knows? It can't be any worse
than what you've done. And I don't know if you know how
lousy your customer service is or even if you care, but
trust me, I'm not coming back and I'm telling everyone I
know about the way I was treated. Oh, and by the way the
next time you have a party, remember this when your cable
goes out”.
Sam Goodheart: Lynn?
Lynn: Yes Mr. Goodheart?
Sam Goodheart: Tell Cindy Reeves that I need to talk to her
right away and have her pull the files on Laura Daniels and
Paul Bridges for review when she gets here.
Lynn: Yes sir.
Sam Goodheart: Oh, and one other thing - tell Stephen that
I'll get back to him later. Earlier you mentioned a
customer who wanted to change her wireless service to
Paragon. What is her name?
Lynn: That would be Caroline Steward, Judge Caroline
Steward, who had some problems with the Technical
Department.
Sam Goodheart: Well maybe its not too late to keep her.
Tell Cindy to pull her file as well. Thanks, Lynn.
Scene 5
At Paragon Company Customer Service Center:
Service Representative: Well . . . Judge Steward, you've called
the right place, let's see what we can do to improve your
service. From what you're telling me, your experience with
Colossal was pretty bad. I mean why give your money to a
company who won't even explain things to you in clear
terms. So just to get this right, please tell me again
while I set up your account.
Judge Steward: Well, I hate to even think about it again.
It makes me so angry. I was at a conference in Chicago,
when I decided to check my messages using my wireless
phone . . .
The following scenes relate to the retelling of Judge
Steward's events with Colossal Communications:
Electronic Operator: We are unable to complete your call at
this time. Please refer to your service provider for
instructions on making a call in this area.
At Colossal Communications Technical Support:
Technical Support Staff: Let me tell, there were some
effects that knocked me out. I mean one of the characters
morphed into something else and the sounds were awesome.
Phone Rings:
Technical Support Staff: Hold on a second let me deal with
this. Tech support, Sharon.
Judge Steward: Is this Tech Support for Colossal
Communications?
Technical Support Staff: Yes? This is Colossal . . . well duh!,
who else would answer these silly calls?
Judge Steward: Well Sharon, I just tried to use my phone
here in Chicago and I have a problem. It seems the only
calls that will go through are to you people.
Technical Support Staff: What do you mean by that? What
happened when you tried to make other calls?
Judge Steward: Uh, I got a recording; it said service in
this area has been restricted by the carrier. What does
that mean in English?
Technical Support Staff: Well, we've removed our reciprocal
exchange agreement from that module due to much fraudulent
activity on analog . . .
Judge Steward: Whoa! What does that mean for someone like
me who is trying to make a legitimate phone call?
Technical Support Staff: It means just what I said, there
have been too many fraudulent claims, our phones are being
cloned by bandits so we removed our interfaces from the
“nn-nexis” in the Chicago area.
Judge Steward: Sharon, I don't want to have to come from
this phone and . . .
End of retelling . . . scene changes back to Paragon Company
Customer Service Center
Judge Steward: It was like Sharon was speaking in another
language, maybe she knows what module agreements and
interfacing “nn-nexis” means but to me it was all just
gibberish. And to top that all off, she had the worst
attitude I have every encountered. She acted like
everything was no big deal. To her it was just par for the
course. But to me this was very serious. When I asked her
how long it would take for this problem to get resolved she
said its company policy. So here I am in Chicago with a
wireless phone that might as well be a paperweight. And
for the next three days I have to make all my calls from a
pay phone . . . that is until an old friend of mine, Julian comes
along. He tells me that all I have to do is reprogram my
phone to access the local wireless carrier. Then I can
make all the calls I need without a problem. Of course,
this bit of useful information comes three days too late,
when its time to go home. Needless to say, I was very
angry with Colossal and its representatives. All she had
to do was tell me how to reprogram my phone; instead I had
to find that out on the last day I'm there from my friend,
Julian. Why couldn't she explain all that technical jargon
in plain English? Paragon has been after our business for
a while, Mr. Meeks. A lot of people here at the courthouse
have already switched over. It seems that I'm the last
hold out.
Service Representative: Let me assure Judge Steward, you've
made the right choice. Paragon has received the Dependable
Dinamo Award for the past three years for providing top
notch service and . . .
Judge Steward: Talk is cheap. You guys promise a good
game, but you see I've learned not to trust sales promise
but to wait and see what a company actually does. Actions,
Mr. Minks, speaks much louder than words. You guys may go
over board to get me to sign up but what are you doing to
keep my business?
Service Representative: Well, we are going to offer
something unique. Real customer service that is
responsive, reliable, and understanding. Now while I have
you on the phone, would you like to change any wireless
accounts, like your husbands as well?
Scene 6
At Colossal Communications Headquarters:
Sam Goodheart: Well folks, we've had a call to arms today
and our customers got a bad connection. We have got to get
to the root of this problem and fix it as a team.
Otherwise we might go the way of the 8-track tape player.
Screen fades . . . end of scene.
End of Scenario

After a user has viewed the streaming video clip, the user clicks on advance button 52, wherein advance button 52 is preferably positioned below graphical video image box 50 and preferably displays instructional title 52A that preferably reads as follows:

PRESS HERE AFTER
VIDEO IS VIEWED

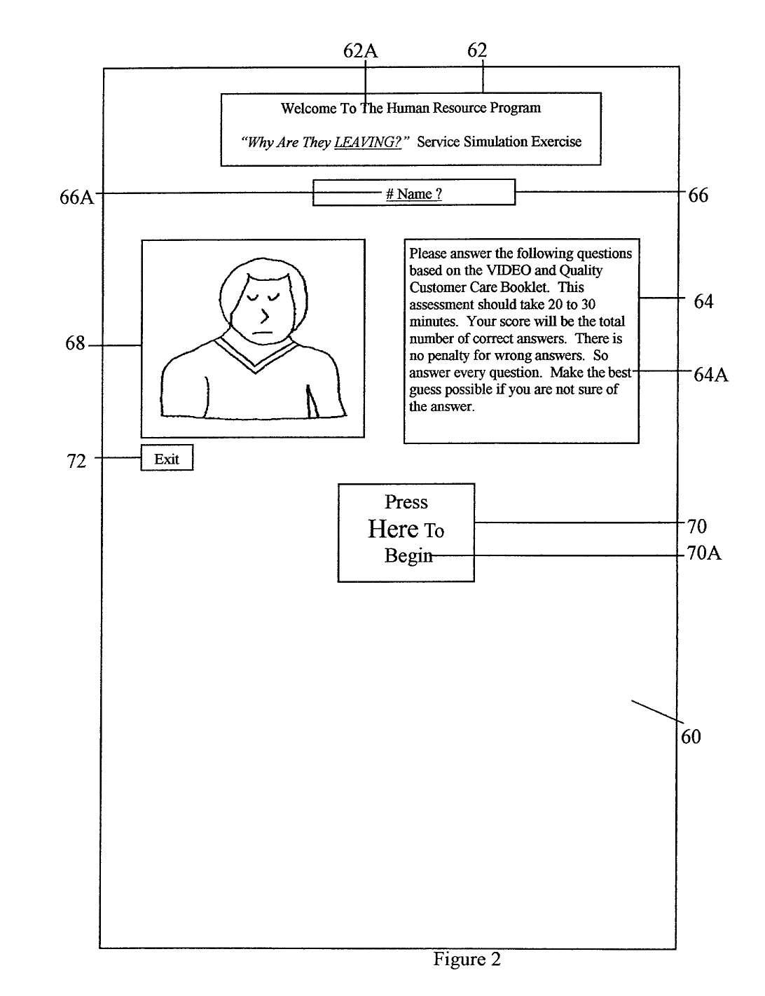

Clicking on advance button 52 preferably prompts a text box to display, wherein the text box requires a user to input his/her name before proceeding. Furthermore, clicking on advance button 52 preferably results in the advancement of graphical image 40 to graphical image 60, wherein graphical image 60 is best depicted in FIG. 2

Referring then to FIG. 2, graphical image 60 preferably comprises information relating to software and method 10, wherein such information preferably includes instructional and/or commencement information, information relating to the objective and/or purpose of software and method 10, video snap-shots, or other information particular to the content of the assessment program and embodied in software and method 10. Graphical image 60 further preferably includes user selectable mechanisms that enable the user to exit, terminate, pause or commence software and method 10. Graphical image 60 further preferably includes user selectable mechanisms that enable the user to advance to subsequent graphical images.

Specifically, graphical image 60 preferably comprises text boxes 62 and 64, data field 66, graphical snap-shot image 68, commencement button 70 and exit button 72, wherein exit button 72 is labeled “EXIT,” and wherein selecting exit button 72 results in the termination of method 10. Text box 62 preferably displays a title 62A, wherein title 62A could be the software title, exercise title, test title or any other desired title. Text box 64 preferably contains an instructional list 64A that reads as follows:

Please answer the following
questions based on the VIDEO and
Quality Customer Care Booklet.
This assessment should take 12 to
18 minutes. Your score will be the
total number of correct answers.
There is no penalty for wrong
answers. So answer every question.
Make the best guess possible if you
are not sure of the answer.

Data field 66 preferably displays prompt 66A, wherein prompt 66A is preferably labeled “#Name?” and preferably functions to instruct or prompt the user to enter a log-in password in data field 66 to access and utilize software and method 10. The log-in password could be the user's name or birth date, a series of alphanumerics, an employer-provided password or any other log-in password desired. Specifically, entry of prompt 66A will allow a host 15 providing software and method 10 (i.e., employer) to access information previously submitted to the host by the user (i.e., employee candidate), wherein such information includes, but is not limited to, resume information, experience level, education level, age, gender, race, Affirmative Action information and/or any other information deemed relevant and/or submitted. Graphical image 60 further preferably comprises a graphical snapshot image 68, wherein graphical snap-shot 68 is preferably a snapshot image of the streaming graphical video as present by graphical video image box 50 from graphical image 40.

Commencement button 70 preferably displays instructional title 70A that reads as follows:

PRESS HERE TO
BEGIN

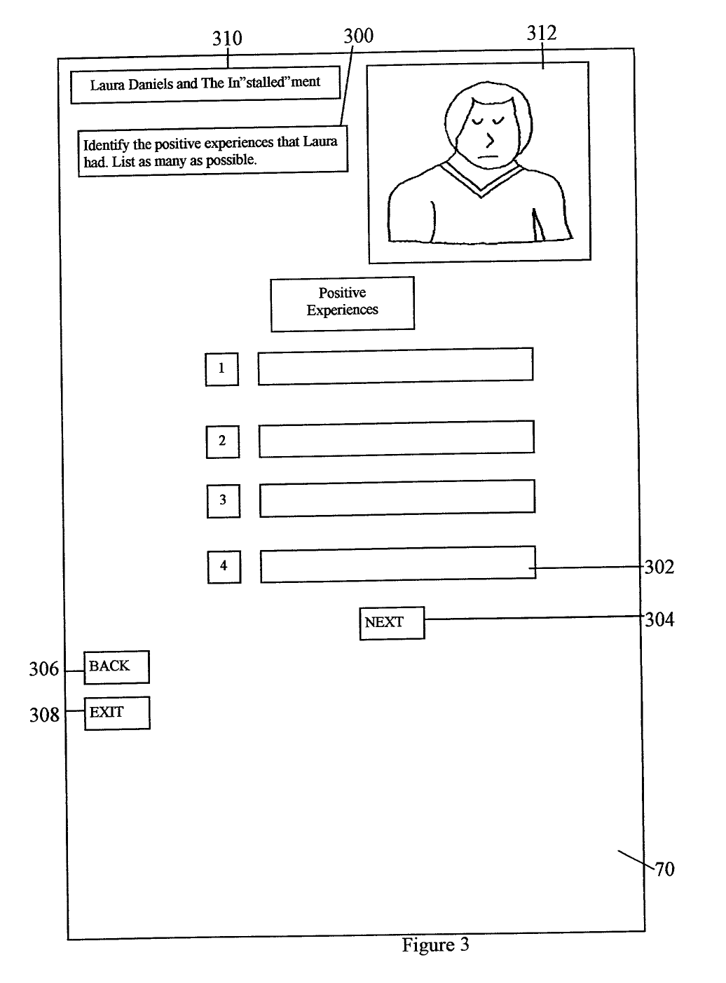

Clicking on commencement button 70 preferably results in the advancement of graphical image 60 to a series of graphical images 70, 80, 90, 100, 110, 120, 130, 140, 150, 160, 170, 180, 200, 210, 220 and 230, wherein graphical images 70, 80, 90, 100, 110, 120, 130, 140, 150, 160, 170, 180, 200, 210, 220 and 230 are best depicted in FIGS. 3-18, respectively.

Referring then to FIGS. 3-17, each of graphical images 70 through 220 preferably comprise information relating to software and method 10, wherein such information preferably includes instructional information, questions and information based upon the content of the streaming digital video or other information/instructions particular to the content of the assessment program and embodied in software and method 10. Each of graphical images 70 through 220 further preferably include user-selectable mechanisms that enable the user to exit, terminate, pause or commence software and method 10. Furthermore, each of graphical images 70 through 220 preferably include user-selectable mechanisms that enable the user to advance to subsequent graphical images or return to previously viewed graphical images.

Specifically, each of graphical images 70 through 220 preferably display a series of questions 300 and a response field 302, wherein a user preferably enters a response to a question 300 within its respective response field 302. Each of graphical images 70 through 220 may further comprise an advance button 304, a return button 306 and an exit button 308, wherein advance button 304 is preferably labeled “NEXT” and preferably allows the user to advance to any of graphical images 70 through 220; return button 306 is preferably labeled “BACK” and preferably allows the user to return or go back to any of previously viewed graphical images 70 through 220; and exit button 308 is preferably labeled “EXIT” and preferably allows the user to terminate method 10 at any desired time. Each of graphical images 70 through 220 further preferably comprise a plurality of text boxes 310 displayed thereon, wherein plurality of text boxes 310 can display any information desired, such as, for exemplary purposes only, questions 300, program or exercise titles, test titles and/or instructional titles. Upon completing questions 300 on any one of graphical images 70 through 220, a user clicks on advance button 304 to advance to successive graphical images 70 through 220 to answer all questions 300 displayed thereon.

Questions 300 are preferably questions based on the streaming graphical videos as provided by graphical video image box 50. As such, questions 300 preferably relate to customer-service complaints, scenarios analysis, mathematical calculations, customer sales, sales ethics, billing inquiries and/or technical support. Additionally, questions 300 can be presented in any form desired, such as, for exemplary purposes only, multiple choice, true-and-false, fill-in-the-blank and/or short-answer. Although it is preferred that questions 300 be based on human resource information or customer-employee relations, it is contemplated in alternate embodiments that questions 300 could be designed to accommodate the needs of any employer and could relate to any aspect of business or service.

Although the content and form of questions 300 are limitless, the following are paradigms of the preferred form and content of questions 300:

### EXAMPLE #1

Identify the positive experiences that Laura had. List as
many as possible.

Positive Experiences:
1. Enter Answer Here
2. Enter Answer Here
3. Enter Answer Here
4. Enter Answer Here

### EXAMPLE #2

Identify the negative experiences that Laura had. List as
many as possible.

Positive Experiences:
1. Enter Answer Here
2. Enter Answer Here
3. Enter Answer Here
4. Enter Answer Here

### EXAMPLE #3

Gaining customers costs money. Colossal invested about
$400 to gain Laura as a customer. Expenses were paid for
advertising, marketing, technical support, customer
service, sales commissions and administrative fees.
In an effort to appease Laura and regain her service, Cindy
Reeves/Customer Service Supervisor, credited the entire $80
equipment charge and asked Laura to only pay her airtime
and monthly services charges. Laura quickly wrote a check
for $70 to move on and put the whole bad experience behind
her.
If Laura's bill had been correct, she would have spent an
average of $55 a month for the first 4 months. After the
equipment charge was paid, her average bill would have been
$35 a month.
1. How much did Colossal lose on Laura Daniels?
2. Including the initial equipment charge, how much would
Laura have paid Colossal in one year?
3. Imagine that all had gone well and Laura was pleased
with Colossal. How much would she have spent if she had
stayed with them for 3 years?
4. Suppose Sandy, the salesperson, incorrectly billed seven
(7) other customers that day. Imagine that they had the
same equipment and monthly fees as Laura. Also assume that
they would have stayed with Colossal for at least three
years. What's the amount of potential revenue lost if they
have the same experience as Laura?
5. How many potential customers will Laura tell about her
experience? Give RANGE. Example: 32 to 268.
6. Assuming the average customer's bill is $35 a month, how
much revenue from potential customers could Colossal lose
as a result of this experience over three years? Give RANGE
based on answer above (question #5). Also include dollar
signs, decimals and cents. EXAMPLE: $16,500.00 to
$84,390.00.
7. Based on Colossal's recent customer survey, 7% of their
customers said that they will switch service because of
negative billing experiences with Colossal. Assuming that
Colossal has a customer base of 700,000 subscribers, how
much potential revenue could be lost in one year due to
customers switching?

### EXAMPLE #4

How did Laura's service representatives violate IMPORTANT
CHARACTERISTICS OF QUALITY CUSTOMER CARE?

Reliability
Perform desired service dependably, accurately and
consistently. A major source of customer dissatisfaction
is unkept promises.
Responsiveness
Should be helpful and provide service over the phone and in
person.
Assurance
Employees should be knowledgeable and courteous. They
should convey confidence in the service they provide.
Empathy
Companies should provide attention and listen when problems
arise. Customers want to be treated as individuals.
1. Enter Response Here
2. Enter Response Here
3. Enter Response Here
4. Enter Response Here

### EXAMPLE #5

A QUALITY organization places emphasis on preventing errors
rather than correcting them. Proactive work results in
less waste, re-work and saves time and money in the long
run. If a problem does occur, early detection and quick
treatment is vital. But focusing on “What could possibly
go wrong?” is the BEST way to prevent customers from ever
having a bad experience.
Choose one answer to each question. Place the LETTER
response in the box.

| 1. | What could Sandy/Sales have done to PREVENT Laura from | |
|---|---|---|
| | receiving an incorrect bill? | |
| | A. | She had done everything possible. |
| | B. | Asked her store assistant to follow up on the |
| | | order. |
| | C. | Checked the billing system after she input the |
| | | order. |
| 2. | What could Sandy have done AFTER recognizing the | |
| | error? | |
| | A. | Informed her supervisor. |
| | B. | Called Laura to advise. |
| | C. | Made correction and called Laura to advise. |

### EXAMPLE #6

Paul spent an average of $48 a month on local phone
service, $23 for long distance and $42 for cable.
While on the road the next day, Paul had a lot of time to
think about his service with Colossal. He had been with
them since his first year in college. Paul had added long
distance two years ago as soon as the company offered it.
Other than brief weather outages, Paul also had not had a
problem with his cable service; seventeen months with no
real complaints was good in his opinion. Now Colossal was
taking him for granted and had not lived up to their
promises. A total of nineteen years of loyal service was
now down the drain!
Please include dollar signs, decimals and cents in each
answer. Examples: $4,855.00 or $7.44
1. How much money has Paul spent with Colossal over the
Years?
2. Paul and his wife had two other couples at the party and
three single friends. How many potential customers will
hear about their experience? Give range. Example: 32 to 150
3. Assuming the average customers' bill is $113 a month for
all three services, how much revenue from potential
customers could Colossal lose as a result of this
experience over three years. Give RANGE based on answer
above (question #2). Also include dollar signs, decimals
and cents. EXAMPLE: $16,500.00 to $84,390.00
4. Based on Colossal's recent customer survey, 5% of their
customers said that they will switch service due to lack of
technical support for cable service. Assuming that the
average customer spends $42 a month on cable, and assuming
that Colossal has a base of 700,000 subscribers, how much
potential revenue could be lost in one year due to
customers switching?

### EXAMPLE #7

Placing emphasis on the prevention of errors rather than
the correction of them has to be done at ALL levels of the
business. Again, time and money are saved in the long run.
Preventing customers from having problems decrease negative
experiences.
1. Marketing advertises “quick response to technical
calls”. However, technical support has six hours to
respond to service calls. In Paul's opinion, what would be
considered “quick”?
2. Even with a “six hour” response time, what exception
could Colossal have made based on special circumstances?
3. Assume that Terry was actually working. What other
responsibilities might he have that prevent him from
responding in a timely manner?
4. What should Technical Support do to live up to “quick
response to service calls”?
5. Joy was very empathetic to Paul. She paged Terry
several times but did not get a response. What else could
she have done to resolve Paul's problem?
6. Marketing insisted on advertising 24-hour support after
agreeing on a six-hour response time with Technical
support. What could they have done to prevent customers
from getting the wrong impression of the service offering?

Questions 300 are preferably further accompanied by digital pictures 312, wherein digital pictures 312 are preferably snapshot graphical images of the streaming graphical videos as presented by graphical video image box 50. As previously described herein, responses to questions 300 are entered into respective response fields 302, wherein the type of responses submitted are used to analyze or assess the skills of the user. Furthermore, any and all response and/or information entered by the user is recorded for reference purposes on the system provided by software and method 10.

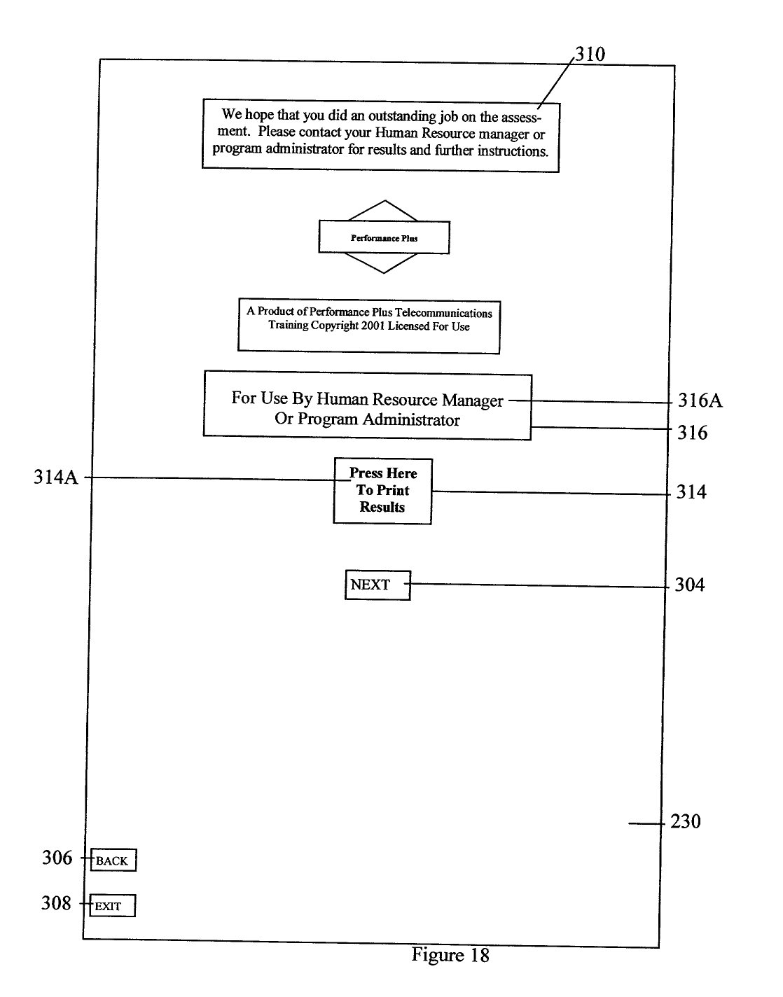

Referring specifically now to FIG. 18, graphical image 230 preferably comprises information relating to software and method 10, wherein such information preferably includes instructional information that informs the user that the program has come to an end or other information/instructions particular to the status and/or content of the assessment program embodied in software and method 10. Graphical image 230 further preferably includes user-selectable mechanisms that enable the user to exit, terminate, pause or commence software and method 10. Moreover, graphical image 230 preferably includes user-selectable mechanisms that enable the user to return to previously viewed graphical images, and further includes employer/recruiter specific instructions and information relating to the method of gathering the user's results and evaluating the same.

Specifically, graphical image 230 preferably possesses advance button 304, return button 306, exit button 308 and plurality of text boxes 310. Specifically, graphical image 230 preferably further comprises a print-results button 314 and text box 316, wherein print-results button 314 preferably displays a message 314A that reads as follows:

Press Here
To Print
Results

Clicking on print-results button 314 results in the printing of all responses and information entered by user into fields 66 and 302. Print-results button 314 is preferably positioned below text box 316 on graphical image 230, wherein text box 316 preferably displays a warning message 316A that reads as follows:

For Use By Human Resource Manager
Or Program Administrator

Arrival at graphical image 230 preferably indicates completion of software and method 10. Furthermore, as indicated by warning message 316A, the contents of graphical image 230, including the results of software and method 10 as provided via the clicking of print-results button 314, are for use by the host of software and method 10, wherein the host is preferably a potential employer of the user.

In an alternate embodiment, it is contemplated that the system provided by method 10 could have more than one graphical video image box presenting more than one graphical streaming video.

In another alternate embodiment, the graphical streaming video presented by graphical video image box could present graphical streaming video of any composition, including, but not limited to, aspects of business training other than those under the purview of human resources, continual learning programs and/or employee-training programs.

In another alternate embodiment, questions 300 could be based on a business aspect or service other than human resources.

In yet another alternate embodiment, each of graphical images 40 through 230 could contain graphical streaming video presented from individual graphical video image boxes disposed on each of graphical images 40 through 230, wherein a series of questions could accompany each different graphical streaming video.

In still another alternate embodiment, graphical streaming videos could be live graphical streaming videos such as, for exemplary purposes only, tele-conferencing via a global network system.

In still another alternate embodiment, method 10 could be coupled with live telephone interactive scenarios, wherein the user would be taken through a series of mock customer-employee relations scenarios, and thereafter asked a series of questions requiring responses via method 10.

In an alternate embodiment, method 10 could be accessed from a desktop computer or via a global networking system.

In an alternate embodiment, the results of a user of method 10 could be made available to an employer/host via hard-copy printouts or electronically via a global networking system.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A computer-based method of interactive assessment, comprising the steps of:
a. obtaining an interactive software program capable of presenting a plurality of videos and related questions requiring user response;
b. having an individual assessee access said interactive software program, wherein said interactive software program comprises a plurality of commands;
c. displaying video images;
d. instructing the individual assessee via said plurality of commands to respond to a plurality of questions in response to said video images;
e. recording said responses to said plurality of questions; and
f. generating assessment data regarding the individual assessee based on said responses to said plurality of questions.

2. The computer-based method of interactive assessment of claim 1, further comprising targeted configurations and specific data inquiries for an individual host of said computer-based method of interactive assessment.

3. The computer-based method of interactive assessment of claim 1, wherein said video images comprise a plurality of situational customer-employee interactions and scenarios.

4. The computer-based method of interactive assessment of claim 1, wherein said video images comprise targeted content to accurately assess specific qualities within an individual assessee based upon the specific needs of an individual host of said computer-based method.

5. The computer-based method of interactive assessment of claim 1, further comprising the step of: instructing the individual assessee via said plurality of commands to respond to said first plurality of questions, wherein said first plurality of questions is presented before said plurality of questions of step d.

6. The computer-based method of interactive assessment of claim 5, wherein said first plurality of questions elicit responses and compile data relating to the individual assessee's skills in remedying employee-customer technical services, resolving customer complaints and transacting customer sales.

7. An interactive individual assessment software program, comprising:
a plurality of commands for manipulating a computer;
a first plurality of displayable inquiries for eliciting input data from an individual to be assessed;
at least one displayable image; and
a second plurality of displayable inquiries for eliciting input data from an individual in response to said at least one displayable image.

8. The interactive individual assessment software program of claim 7, wherein said interactive software is accessible via a global network system.

9. The interactive individual assessment software program of claim 7, further comprising a security interface requiring password input for program operation.

10. The interactive individual assessment software program of claim 7, wherein said first plurality of inquiries for input data is selected from the group consisting of demographic data inquiries, education data inquiries, personal information data inquiries and employment experience inquiries.

11. The interactive individual assessment software program of claim 7 further comprising targeted configurations and specific data inquiries for an individual host of said employee candidate assessment software.

12. The interactive individual assessment software program of claim 7, wherein said at least one displayable image comprises a plurality of situational customer-employee interactions and scenarios.

13. The interactive individual assessment software program of claim 7, wherein said at least one displayable image is a video having a plurality of displayable images.

14. The interactive individual assessment software program of claim 7, wherein said at least one displayable image comprises targeted content to accurately assess specific qualities within an individual assessee based upon the specific needs of an individual host of said employee candidate assessment software.

15. The interactive individual assessment software program of claim 7, wherein said second plurality of inquiries for input data elicits responses, and wherein said commands direct the computer to compile data relating to the individual assessee's skills in remedying employee-customer technical services, resolving customer complaints and transacting customer sales in response to said second plurality of inquiries.

16. A self-guided interactive interview software program, comprising;
interactive graphical interface commands executable by a computer;
a first plurality of displayable inquiries for eliciting input data from an individual to be assessed;
an image database having a plurality of video images having targeted content to accurately assess specific qualities within an individual assessee based upon the specific needs of an individual host of said self-guided interactive interview software;
a second plurality of displayable inquiries for eliciting input data from an individual in response to said plurality of video images retrievable from said image database; and
means for preparing a report based on said first and second plurality of displayable inquiries.

17. The self-guided interactive interview software of claim 16, wherein said interview software is accessible via a global network system.

18. The self-guided interactive interview software of claim 16, wherein said first plurality of inquiries for input data is selected from the group consisting of demographic data inquiries, education data inquiries, personal information data inquiries and employment experience inquiries.

19. The self-guided interactive interview software of claim 16, wherein said plurality of video images further comprises a plurality of situational customer-employee interactions and scenarios.

20. The self-guided interactive interview software of claim 16, wherein said second plurality of inquiries for input data elicits responses and compiles data relating to the individual assessee's skills in remedying employee-customer technical services, resolving customer complaints and transacting customer sales.
